(19) United States
(12) Patent Application Publication
(10) Pub. No.: US 2008/0205914 A1
(43) Pub. Date: Aug. 28, 2008

(54) IMAGE FORMING APPARATUS AND JAM-REMOVAL METHOD THEREOF

(76) Inventor: Sang Uk Jeon, Yongin-si (KR)

Correspondence Address: STANZIONE & KIM, LLP, 919 18TH STREET, N.W., SUITE 440, WASHINGTON, DC, 20006, US

(21) Appl. No.: 12/035,571

(22) Filed: Feb. 22, 2008

(30) Foreign Application Priority Data
Feb. 27, 2007 (KR) 2007-0019577
Mar. 9, 2007 (KR) 2007-0023548

(51) Int. Cl. G03G 15/00

(52) U.S. Cl. 399/21

(57) ABSTRACT

An image forming apparatus including an image forming apparatus body having an aperture for the removal of a jammed printing medium, a printing engine installed in the image forming apparatus body to print an image on a printing medium supplied thereto, and a jam-removal device installed to the image forming apparatus body in an upwardly movable manner, so as to remove a jammed printing medium from the image forming apparatus body. As the jam-removal device, capable of opening or closing the aperture for the removal of the printing medium jammed in the body, can be sliding moved in an upward direction of the image forming apparatus body, the image forming apparatus can achieve a reduced installation space thereof.

### CROSS-REFERENCE TO RELATED APPLICATIONS

This application claims the benefit of Korean Patent Applications No. 2007-0019577, filed on Feb. 27, 2007 and No. 2007-0023548, filed on Mar. 9, 2007, in the Korean Intellectual Property Office, the disclosure of which is incorporated herein by reference.

### BACKGROUND OF THE INVENTION

1. Field of the Invention

The present general inventive concept relates to an image forming apparatus, and, more particularly, to an image forming apparatus to reduce an installation space thereof and a jam-removal method thereof.

2. Description of the Related Art

Generally, an image forming apparatus is an apparatus to print a black-and-white image or color image on a printing medium, such as a sheet of paper, on the basis of an image signal. Examples of the image forming apparatus include a laser printer, an ink-jet printer, a copying machine, a multi-function machine, a facsimile, etc. Representative image forming methods of these various kinds of image forming apparatuses include an electro-photographic method and an ink-jet method. In the electro-photographic method, a light beam is scanned onto a photosensitive member so as to form an electrostatic latent image, and a toner is attached onto the electrostatic latent image so as to transfer the electrostatic latent image onto a printing medium. In the ink-jet method, liquid-phase ink is injected onto a surface of a printing medium on the basis of an image signal.

In the above mentioned image forming apparatus, a printing medium is supplied, one by one, to an electro-photographic or ink-jet type printing engine, and an image is printed on a surface of each printing medium on the basis of an image signal. After undergoing the printing operation, the printing medium is discharged to the outside of the image forming apparatus.

The image forming apparatus is provided, inside a discharge outlet thereof, with a jam-removal device to discharge the printed printing medium to the outside. The jam-removal device includes a plurality of rollers to convey the printing medium, and a jam-removal cover arranged to support the rollers and adapted to open the discharge outlet to remove a printing medium jammed in a body of the image forming apparatus after undergoing a printing operation.

Japanese Patent Laid-Open Publication No. 2000-0305392 (filed on Apr. 20, 1994) discloses an image forming apparatus having the above described kind of jam-removal device.

The conventional image forming apparatus, disclosed in the above Publication, is an electro-photographic image forming apparatus, and has an opening/closing jam-removal cover coupled to a body of the image forming apparatus. For the conveyance of a printed printing medium, the jam-removal cover is provided with a roller, which cooperates with a discharge roller installed in the body of the image forming apparatus, so as to discharge the printed printing medium. The jam-removal cover is installed adjacent to a fixing device used to fix a toner image onto the printing medium. The jam-removal cover has one end hingedly coupled to the body of the image forming apparatus and the other end having a coupling pin to be coupled to the image forming apparatus body.

In the above described conventional image forming apparatus, if the printed printing medium is jammed in the body of the image forming apparatus prior to being discharged, the jam-removal cover is rotated in a direction horizontal to the ground surface about a hinge shaft, so as to expose a part of a discharge structure defined in the body of the image forming apparatus. Thereby, the printing medium, jammed in a printing engine, such as the fixing device, etc., can be pulled and removed through the exposed discharge structure.

However, a problem of the conventional image forming apparatus is that the image forming apparatus requires a sufficiently wide installation space required for rotation of the jam-removal cover because the jam-removal cover should be rotated in a horizontal direction of the ground surface about the hinge shaft of the image forming apparatus body.

Therefore, the conventional image forming apparatus suffers from a restriction in an installation space thereof and has a difficulty to remove a jammed printing medium when it is installed in a small space.

### SUMMARY OF THE INVENTION

The present general inventive concept provides an image forming apparatus, which has no serious restriction in an installation space thereof and can guarantee easy removal of a jammed printing medium even when it is installed in a small space, and a jam-removal method thereof.

Additional aspects and/or utilities of the present general inventive concept will be set forth in part in the description which follows and, in part, will be obvious from the description, or may be learned by practice of the present general inventive concept.

The foregoing and/or other aspects and utilities of the present general inventive concept may be achieved by providing an image forming apparatus including: an image forming apparatus body having an aperture for the removal of a jammed printing medium; a printing engine installed to the image forming apparatus body, to print an image on a printing medium supplied thereto; and a jam-removal device installed to the image forming apparatus body in an upwardly movable manner, to remove a jammed printing medium from the image forming apparatus body.

The jam-removal device may include: a frame coupled to the image forming apparatus body in a sliding movable manner; and a discharge roller installed in the frame to convey the printing medium, which was printed with the image, to the outside of the image forming apparatus body.

The image forming apparatus may further include: a position-fixing device to fix the frame to the image forming apparatus body.

Any one of the frame and the image forming apparatus body may include a sliding groove, and the other one of the frame and the image forming apparatus body may comprise a guide protrusion to be inserted into the sliding groove in a sliding movable manner to guide the frame.

The sliding groove may include an upper position-fixing member to fix the guide protrusion at an upwardly moved position.

The upper position-fixing member may be an elastic member to be elastically deformed by a pressure force applied by the guide protrusion.

The sliding groove may include a lower position-fixing member to fix the guide protrusion at a downwardly moved position.

The lower position-fixing member may be an elastic member to be elastically deformed by a pressure force applied by the guide protrusion.

The discharge roller may be coupled with a roller drive gear, and the image forming apparatus body includes a drive gear to be engaged with the roller drive gear.

The image forming apparatus may further include: a frame lifting device to vertically move the frame.

The foregoing and/or other aspects and utilities of the present general inventive concept may also be achieved by providing an image forming apparatus including: a printing medium supply device to store and supply a printing medium; a printing engine to form an image on the printing medium conveyed from the printing medium supply device; a discharge structure from which the printing medium, having the image formed by the printing engine, is discharged; and a jam-removal device installed on a conveyance path of the printing medium in an upwardly movable manner.

The image forming apparatus may further include: an image forming apparatus body having an aperture, and the jam-removal device may be installed to the image forming apparatus body, to guide the printing medium, having passed through the printing engine, to the outside of the image forming apparatus body, and to open the aperture.

A feeding roller may be provided between the printing medium supply device and the printing engine, to convey the printing medium, supplied from the printing medium supply device, to the printing engine, and the jam-removal device may comprise a guide member to guide the printing medium being conveyed by the feeding roller. The guide member may be rotated and moved substantially horizontally and upward, to remove the printing medium jammed in the conveyance path between the feeding roller and the guide member.

The foregoing and/or other aspects and utilities of the present general inventive concept may also be achieved by providing a jam-removal method of an image forming apparatus, the method including: sensing a jam error of a printing medium being conveyed to a discharge structure of an image forming apparatus body; stopping an operation of a printing medium discharge roller when the printing medium being conveyed to the discharge structure is jammed; opening an aperture formed in the discharge structure by upwardly moving a jam-removal device covering the aperture, to remove the jammed printing medium; and forcibly discharging the printing medium through the aperture.

During the opening of the aperture, the jam-removal device may be slidingly moved by a predetermined distance so as not to be separated from the image forming apparatus body.

The foregoing and/or other aspects and utilities of the present general inventive concept may also be achieved by providing a image forming apparatus, including an image forming apparatus body having an aperture in which recording media having images printed thereon are ejected therefrom; a printing engine within the image forming apparatus body to print an image on the recording media; and a jam-removal device including a frame slidingly installed at the aperture to be slidable in a direction perpendicular to the direction in which the recording media are ejected therefrom and along an outer surface of the image forming apparatus body such that a jammed recording medium within the image forming apparatus body can be accessed by sliding the jam-removal device.

The jam-removal device can include elongated sliding grooves along opposing inner surfaces of the aperture; and guide protrusions extending outwardly from opposing outer surfaces of the frame to slide along inner surfaces of corresponding ones of the elongated sliding grooves.

The elongated sliding grooves can include first position fixing members at first ends thereof to limit the sliding movement of the guide protrusions in a first direction; and second position fixing members at second ends thereof to limit the sliding movement of the guide protrusions in a second direction.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 is a side sectional view schematically illustrating an image forming apparatus according to a an embodiment of the present general inventive concept;

FIG. 2 is an exploded perspective view illustrating the configuration of important parts of the image forming apparatus according to the embodiment of FIG. 1;

FIG. 3 is a sectional view illustrating an exemplary jam-removal device for the image forming apparatus according to the embodiment of FIG. 1;

FIG. 4 is a perspective view illustrating an exemplary operation of the image forming apparatus according to the embodiment of FIG. 1;

FIG. 5 is a sectional view illustrating a jam-removal device for an image forming apparatus according to another embodiment of the present general inventive concept;

FIG. 6 is a block diagram illustrating important parts of the image forming apparatus according to the embodiment of FIG. 5;

FIG. 7 is a side sectional view schematically illustrating an image forming apparatus according to still another embodiment of the present general inventive concept;

FIG. 8 is a perspective view schematically illustrating a jam-removal device for the image forming apparatus of FIG. 7; and

FIGS. 9A to 9C are side sectional views illustrating a jam-removal method of the image forming apparatus of FIG. 7.

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

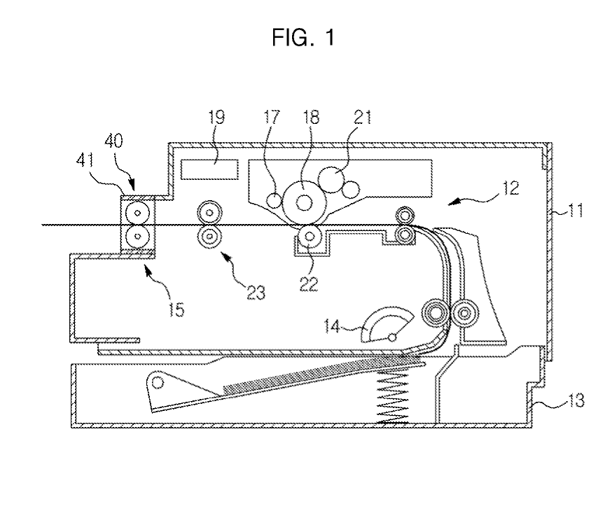

As illustrated in FIG. 1, an image forming apparatus according to an embodiment of the present general inventive concept is a laser printer in which a developing agent is attached to a photosensitive member 18 formed with an electrostatic latent image, to form a visible image, and the visible image is transferred onto a printing medium.

The image forming apparatus comprises a body 11 defining the outer appearance of the image forming apparatus, a printing engine 12 to print an image on a printing medium supplied thereto, a printing medium supply device 13 to load a plurality of printing media therein for the sequential supply of each printing medium, the printing medium supply device 13 being detachably coupled to the image forming apparatus body 11, a pickup device 14 to pick up the printing medium, loaded in the printing medium supply device 13, one by one, and a jam-removal device 40 to guide a printed printing medium to the outside of the image forming apparatus body 11 and to remove a printing medium jammed in a discharge structure 15.

In the image forming apparatus according to the embodiment of FIG. 1, if a printing operation begins, the pickup device 14 is operated to pick up the printing medium, loaded in the printing medium supply device 13, one by one, and to convey the printing medium to the printing engine 12. If the picked-up printing medium is conveyed to the printing engine 12, the printing medium is subjected to a printing operation, and thereafter, is discharged to the outside of the body 11 of the image forming apparatus through the discharge structure 15.

While the printing medium is picked up and conveyed to the printing engine 12, a laser beam, which is scanned from an exposure unit 19 on the basis of an image signal, is introduced onto a surface of the photosensitive member 18 that was electrically charged with a predetermined electric potential by an electric charger 17, so as to form an electrostatic latent image. Then, as toner particles are attached to the electrostatic latent image on the surface of the photosensitive member 18 by a developing roller 21, a visible image in the form of powder is formed on the surface of the photosensitive member 18. The formed visible image is transferred onto a surface of each printing medium by a transfer device 22 in the course of conveying the printing medium. Thereafter, the visible image, transferred onto the printing medium, is fixed onto the surface of the printing medium as it is molten upon receiving a pressure and heat while the printing medium passes through a fixing device 23. The printing medium, having passed through the fixing device 23, is guided by the jam-removal device 40, so as to be discharged to the outside of the body 11 of the image forming apparatus through the discharge structure 15.

The above described serial image forming procedure can be performed sequentially, and the printing medium, loaded in the printing medium supply device 13, can be sequentially supplied to the printing engine 12 and be discharged to the outside through the discharge structure 15 after undergoing a printing operation.

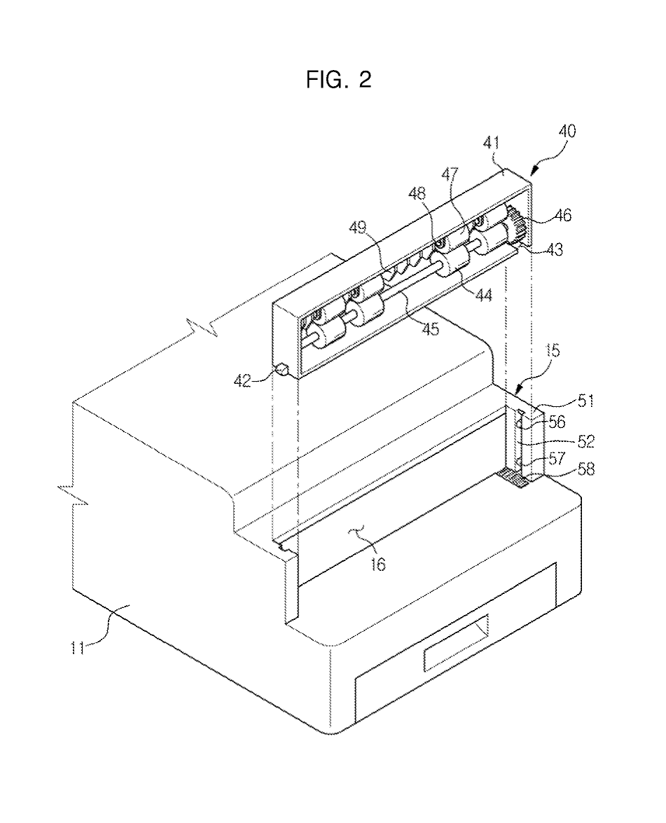

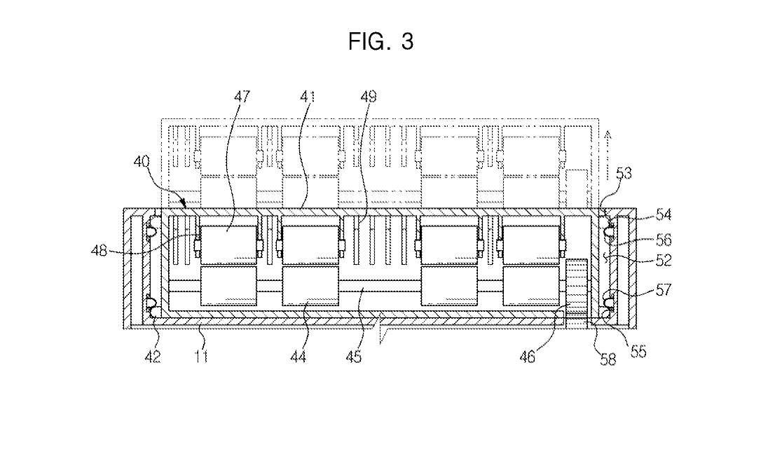

The jam-removal device 40, as illustrated in FIGS. 2 and 3, is mounted in the discharge structure 15 in a vertically sliding movable manner, to open an aperture 16 perforated in the discharge structure 15 of the body 11 of the image forming apparatus. The jam-removal device 40 includes a frame 41 having opened front and rear sides, a plurality of discharge rollers 44 arranged within the frame 41 and adapted to convey the printing medium to the discharge structure 15, and a plurality of idle rollers 47 arranged in contact with the respective discharge rollers 44.

The frame 41 is disposed, in a vertically sliding movable manner, on supports 51 located at left and right sides of the aperture 16. The supports 51 have elongated sliding grooves 52, respectively, which extend approximately perpendicular to the ground surface. The frame 41 is provided, at left and right outer surfaces thereof, with guide protrusions 42, which are configured to be inserted into the respective sliding grooves 52 in a slidingly movable manner. As the guide protrusions 42 are moved along the sliding grooves 52 during the sliding movement of the frame 41, the frame 41 can be guided by the guide protrusions 42 such that it is moved in a direction approximately perpendicular to the ground surface. Of course, it will be appreciated that the sliding grooves 52 may have an alternative positioning than that perpendicular to the ground surface, such as, for example, a slight tilt to the ground surface.

Each sliding groove 52 has a stepped portion 53 formed at an upper end thereof, to restrict movement of the guide protrusion 42 so as to prevent the guide protrusion 42 from being separated from the sliding groove 52. An upper position-fixing member 56 is provided in the sliding groove 52 below the stepped portion 53, to keep the upwardly sliding moved guide protrusion 42 at a fixed position. Also, a lower position-fixing member 57 is provided in a lower position of the sliding groove 52, to keep the downwardly sliding moved guide protrusion 42 at a fixed position. Both the upper and lower position-fixing members 56 and 57 are elastically deformable members, and are mounted in upper and lower mounting recesses 54 and 55 defined in the sliding groove 52, respectively. Each position-fixing member 56 or 57 can be pushed and elastically deformed by the guide protrusion 42, which is forcibly moved when the frame 41 is manually moved upward and downward. Then, the position-fixing members 56 or 57 are returned to their original state if the guide protrusion 42 is moved away from the position-fixing members 56 or 57. To allow the guide protrusion 42 to easily pass through the respective position-fixing members 56 and 57 during the upward and downward movements of the frame 41, a portion of each position-fixing member 56 or 57, protruding from the sliding groove 52, has a curved surface, and an end of the guide protrusion 42 in contact with the position-fixing member 56 or 57 has a curved surface.

If the frame 41 is manually pushed and moved to its lowermost position, the movement of the guide protrusion 42 is restricted by the second position-fixing member 57 and thus, the frame 41 is fixed at the lowermost position. Then, if the frame 41 is manually pulled and moved to its uppermost position, the movement of the guide protrusion 42 is restricted by the upper position-fixing member 56 and thus, the frame 41 is fixed at the uppermost position.

In addition to the guide protrusions 42 and the sliding grooves 52, a variety of other elements capable of vertically moving the jam-removal device 40 relative to the body 11 of the image forming apparatus, such as guide rails, guide bars, etc., may be used to vertically slide the jam-removal device 40.

Also, in addition to the above described elastic members, a variety of other fixing elements, such as hooks, etc., may be used to fix the jam-removal device 40 at an upper or lower position of the sliding groove 52 while guaranteeing the jam-removal device 40 to be released from its fixed position by a user's operation.

The plurality of discharge rollers 44 are coupled to a roller shaft 45 that is rotatably installed within the frame 41, and a roller drive gear 46 is coupled to an end of the roller shaft 45. The roller drive gear 46 engages with a drive gear 58 that is mounted in the body 11 of the image forming apparatus when the jam-removal device 40 is in its normal position guiding the printing medium. For the engagement of the roller drive gear 46 and the drive gear 58, the frame 41 has an opening, in the bottom thereof, which can be provided as a slit 43.

The idle rollers 47 are arranged above the respective discharge rollers 44 and operated, together with the discharge rollers 44, to completely discharge a printed printing medium to the outside. The idle rollers 47 are supported by roller supporting members 48 provided within the frame 41 and rotated, together with the discharge rollers 44, in contact with the discharge rollers 44. A plurality of discharge guide ribs 49 are arranged at the side of the idle rollers 47 and used to push an upper surface of each printing medium to assist the printing medium to be discharged with a correctly aligned state. The discharge guide ribs 49 are integrally formed with the inner top surface of the frame 41.

Hereinafter, an operation of the image forming apparatus in accordance with an embodiment of the present general inventive concept will be described with reference to the accompanying drawings.

When the image forming apparatus is in a printing ready state, the jam-removal device 40 is fixed to the body 11 of the image forming apparatus under the operation of the position-fixing member 57 such that it covers the aperture 16 and the roller drive gear 46 is engaged with the drive gear 58 mounted in the body 11 of the image forming apparatus.

If a printing operation begins, the printing medium, loaded in the printing medium supply device 13, is picked up one by one and conveyed to the printing engine 12. The printing engine 12 prints an image on the printing medium being conveyed. Then, a main drive device (not shown) to rotate the drive gear 58 is operated, thereby causing the discharge rollers 44 and the idle rollers 47 of the jam-removal device 40 to be rotated in a direction of discharging the printing medium.

During the normal conveyance of the printed printing medium, the printing medium, having passed through the printing engine 12, is discharged to the outside of the body 11 of the image forming apparatus by the discharge rollers 44 and the idle rollers 47.

However, when the printing medium is caught by the fixing device 23 or other elements of the printing engine 12 in the course of being conveyed to the discharge structure 15 and thus, the normal conveyance of the printing medium is impossible, the printing operation stops and the operation of the main drive device stops to stop rotation of the discharge rollers 44.

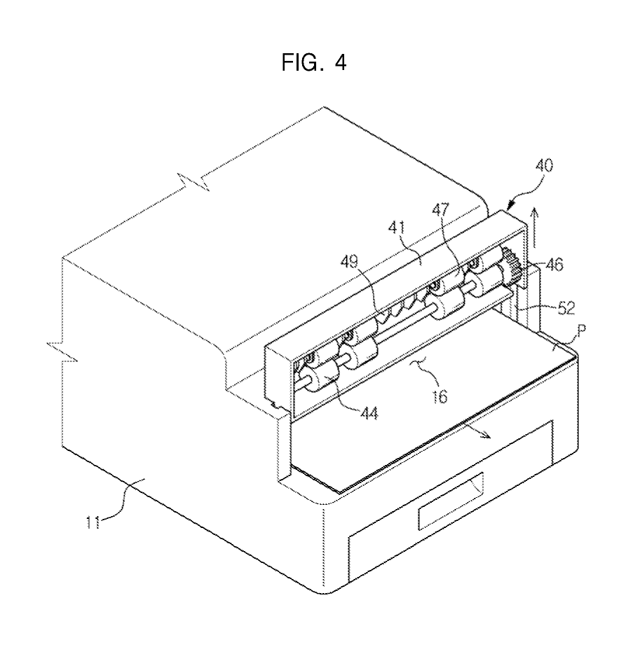

In a state wherein the printing operation stops due to a jam error, if the frame 41 of the jam-removal device 40 is manually pulled upward by a user, as illustrated in FIG. 4, the frame 41 is sliding moved upward along the sliding grooves 52 as the guide protrusions (42, See FIG. 3) of the frame 41 are separated from the lower position-fixing members (57, See FIG. 3). When the frame 41 is pulled up to the uppermost position thereof by the user, the guide protrusions 42 of the frame 41 are caught by the upper position-fixing members (56, See FIG. 3). Thereby, the frame 41 is fixed at the uppermost position and the aperture 16 formed in the body 11 of the image forming apparatus is opened. Once the aperture 16 is opened, the user is able to pull the printing medium P, jammed in the body 11 of the image forming apparatus, through the aperture 16, so as to forcibly discharge the jammed printing medium P to the outside.

With the above described image forming apparatus according to an embodiment of the present general inventive concept, since the jam-removal device 40 can be sliding moved upward to open the aperture 16 when a jam error occurs, it is unnecessary to provide a space, required for the movement of the jam-removal device 40, around the body 11 of the image forming apparatus. Accordingly, the image forming apparatus can achieve a reduced installation space thereof.

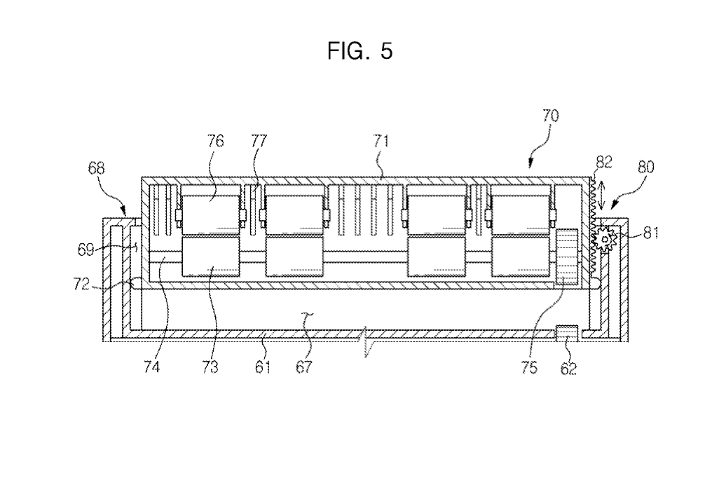

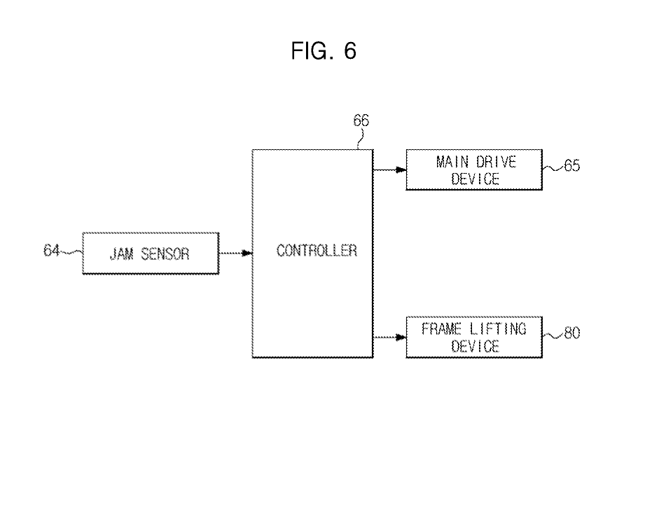

FIGS. 5 and 6 illustrate a partial configuration of an image forming apparatus according to another embodiment of the present general inventive concept.

Similar to the image forming apparatus of the previously described embodiment, the image forming apparatus according to the present embodiment is configured such that a jam-removal device 70, for the guidance of a printing medium to be discharged, is installed to a discharge structure 68 in a vertically sliding movable manner, so as to open or close an aperture 67 formed in a body 61 of the image forming apparatus.

The image forming apparatus according to the present embodiment includes a frame lifting device 80 to vertically move a frame 71 of the jam-removal device 70, a jam sensor 64 to sense a jam error of a printing medium, and a controller 66 to operate a main drive device 65 and the frame lifting device 80 in response to a signal from the jam sensor 64.

The body 61 of the image forming apparatus is formed, at left and right sides of the aperture 67, with a pair of sliding grooves 69. The frame 71 of the jam-removal device 70 is formed, at left and right sides thereof, with a pair of guide protrusions 72 configured to be inserted into the respective sliding grooves 69. The frame 71 includes a roller shaft 74 coupled with a roller drive gear 75, which engages with a drive gear 62 to be driven by the main drive device 65, a plurality of discharge rollers 73 supported on the roller shaft 74, a plurality of idle rollers 76 installed in contact with the respective discharge rollers 73, and discharge guide ribs 77 arranged at the side of the idle rollers 76.

The frame lifting device 80 includes a pinion gear 81 installed in one of the sliding grooves 69, and a rack gear 82 provided at one side of the frame 71 of the jam-removal device 70, so as to be engaged with the pinion gear 81. The pinion gear 81 is operated by the main drive device 65 or another separate drive device. Whether the pinion gear 81 is rotated clockwise or counter-clockwise, the frame 71 is moved upward or downward along the sliding groove 69 in a direction approximately perpendicular to the ground surface.

In the image forming apparatus having the above described configuration according to the embodiment of FIG. 5, when a printing medium is normally conveyed from the printing medium supply device (13, See FIG. 1) to the outside of the body 61 of the image forming apparatus through the discharge structure 68, the jam-removal device 70 is located at the lowermost position thereof and covers the aperture 67. In this case, the frame 71 is fixed as the pinion gear 81 and the rack gear 82 are kept in a stationary state while being engaged with each other, and the roller drive gear 75 is engaged with the drive gear 62 of the body 61 of the image forming apparatus.

If the printing medium is jammed in the course of being conveyed to the discharge structure 68 during a printing operation and thus, the conveyance of the printing medium is restricted, the jam sensor 64 detects the restriction in the conveyance of the printing medium, thereby sending a signal to the controller 66. The controller 66 stops the printing operation in response to the signal and also, stops the rotation of the discharge rollers 73 by operating the main drive device 65 or clutch unit (not shown). Thereafter, the controller 66 rotates the pinion gear 81 forward (i.e. clockwise) for a predetermined time. In this case, the jam-removal device 70 having the rack gear 82 stops after being moved upward by a predetermined distance.

If the aperture 67 is opened via the upward movement of the jam-removal device 70, the user is able to pull and remove the printing medium, jammed in the body 61 of the image forming apparatus, through the aperture 67. Once the jammed printing medium is discharged to the outside through the aperture 67, the jam sensor 64 detects the removal of the jammed printing medium, and the frame lifting device 80 is automatically or manually operated to return the jam-removal device 70 to its original position.

In the embodiment of FIG. 5, it will be appreciated that the frame lifting device 80 may alternatively use a variety of other linear moving elements, such as linear gears, ball screws, etc., in place of the above described rack-and-pinion structure.

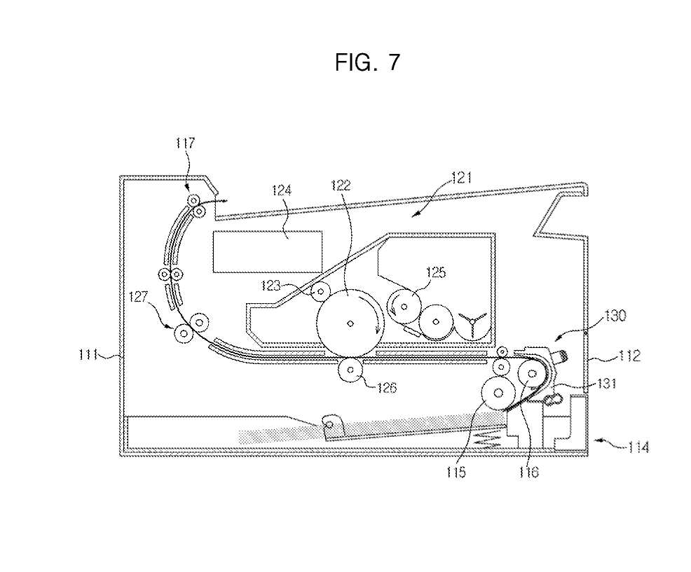

FIG. 7 is a side sectional view schematically illustrating an image forming apparatus according to still another embodiment of the present general inventive concept.

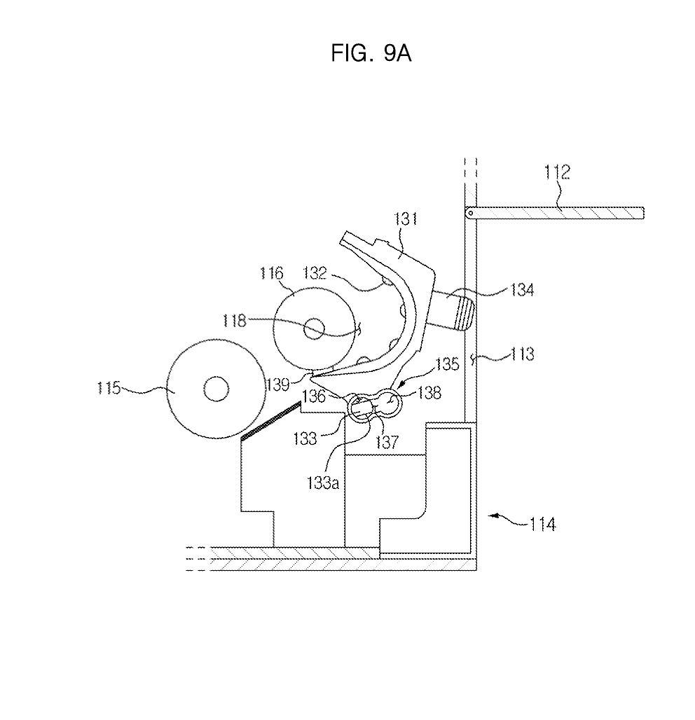

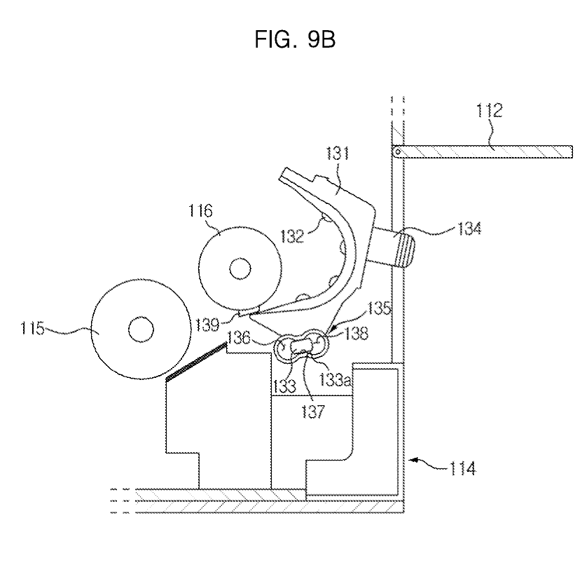

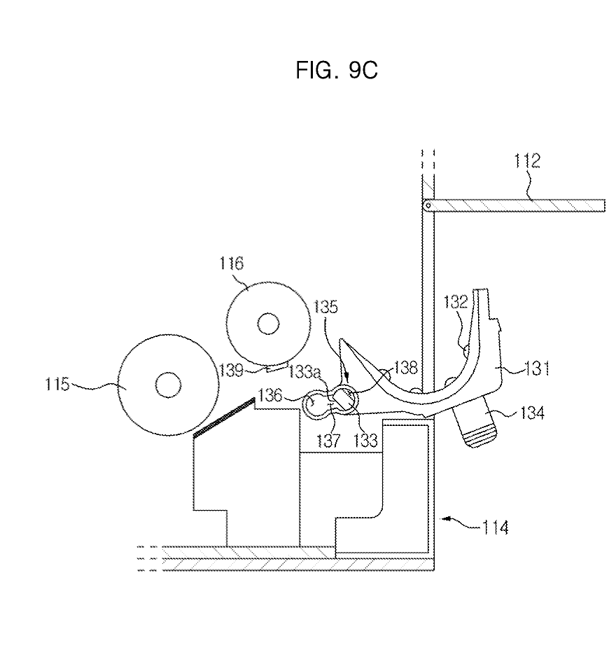

Referring to FIG. 7, the image forming apparatus of the present embodiment comprises a body 111 defining the outer appearance of the image forming apparatus, a printing medium supply device 114 installed in the bottom of the body 111, a printing engine 121 to print an image on a printing medium, a jam-removal device 130 installed to be capable of moving away and being spaced apart from a feeding roller 116 to remove a jammed printing medium being conveyed by the feeding roller 116, and a printing medium discharge device 117 to discharge a completely printed medium to the outside. The body 111 of the image forming apparatus is formed, at a portion thereof, with an aperture 113 (FIG. 9A) for the removal of the jammed printing medium. The aperture 113 is opened and closed by an opening/closing cover 112.

The printing engine 121 includes a photosensitive member 122 on which an electrostatic latent image is formed, an electric charger 123 to electrically charge a surface of the photosensitive member 122 by a predetermined electric potential, an exposure unit 124 to irradiate a light beam onto the photosensitive member 122 to form the electrostatic latent image on the photosensitive member 122, a developing roller 125 to attach a developing agent onto the photosensitive member 122 formed with the electrostatic latent image, a transfer device 126 to transfer a visible image formed on the photosensitive member 122 to a printing medium, and a fixing device 127 to fix the transferred visible image on the printing medium.

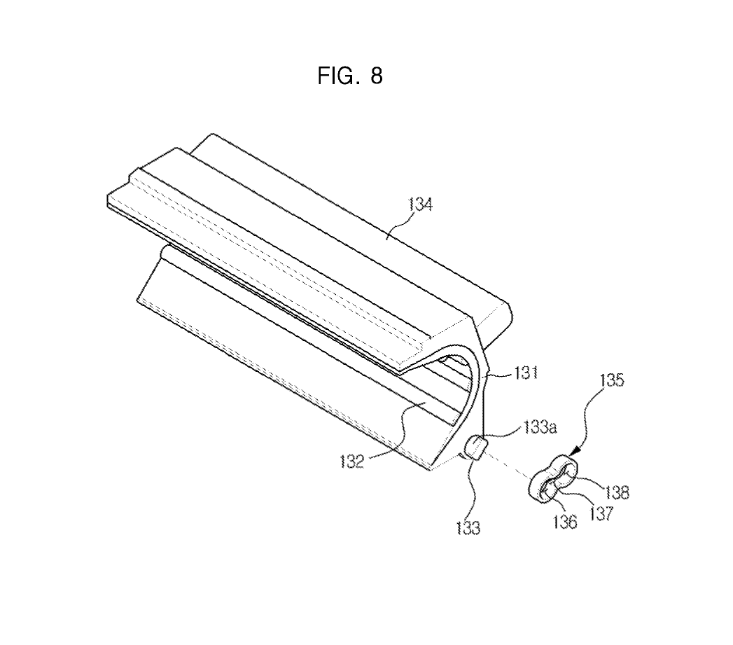

The jam-removal device 130 includes a guide member 131 to guide the printing medium being conveyed by the feeding roller 116. The guide member 131 is located to surround a side of the feeding roller 116. As illustrated in FIG. 8, the guide member 131 is provided, at an inner surface thereof facing the feeding roller 116, with a plurality of idle rollers 132 such that the idle rollers 132 are rotated in contact with the feeding roller 116. A conveyance path 118 is defined between the feeding roller 116 and the guide member 131 such that a printing medium picked up by a pickup device 115 is conveyed along the conveyance path 118.

The guide member 131 is installed in a rotatable manner. Accordingly, when the printing medium is jammed in the course of being conveyed along the conveyance path 118 between the feeding roller 116 and the guide member 131, the jammed printing medium can be easily removed by a rotation of the guide member 131. For this, the guide member 131 has a hinge shaft 133 provided at a lower position thereof. The hinge shaft 133 is fitted into a hinge 135 provided at a side of the image forming apparatus body 111, to be rotated about the hinge 135. As the hinge shaft 133 fitted into the hinge 135 is rotated, the guide member 131 is rotated about the hinge shaft 133.

As illustrated in FIG. 8, the hinge shaft 133 has a double D-cut shape having two opposite planes 133a. The hinge 135 has first and second hinge holes 136 and 138, and a connecting portion 137 to connect the first and second hinge holes 136 and 138 with each other. Here, the first hinge hole 136 is a region where the hinge shaft 133 is located when the feeding roller 116 comes into contact with the plurality of idle rollers 132. The connecting portion 137 is a region where the hinge shaft 133 is moved between the first hinge hole 136 and the second hinge hole 138. The connecting portion 137 has a smaller width than that of the first and second hinge holes 136 and 138 such that the hinge shaft 133 passes the connecting portion 137 only when the hinge shaft 133 is rotated by a predetermined angle to keep the planes 133a level with the connecting portion 137. The second hinge hole 138 is a region where the hinge shaft 133 is located when the guide member 131 is spaced apart from the feeding roller 116 by a predetermined interval to remove the printing medium jammed in the conveyance path 118 between the feeding roller 116 and the guide member 131. The hinge 135 is oriented to have a slight tilt such that a height of the second hinge hole 138 is slightly higher than a height of the first hinge hole 136.

The guide member 131 is provided, at an outer surface thereof, with an outwardly protruding handle 134 to allow a user to easily operate the guide member 131. When the printing medium is jammed in the conveyance path 118, the guide member 131 can be moved away and spaced apart from the feeding roller 116 as the user pulls the handle 134.

A stopper 139 is provided at the guide member 131 below the feeding roller 116. To prevent interference between the stopper 139 and the feeding roller 116, the stopper 139 is spaced apart from a surface of the feeding roller 116. When the guide member 131 is rotated in a state wherein the hinge shaft 133 is located in the first hinge hole 136, the stopper 139 restricts a rotation angle of the guide member 131 such that the planes 133a of the hinge shaft 133 are parallel to the connecting portion 137.

A method of removing a printing medium jammed in the image forming apparatus according to the embodiment of FIG. 7 will be described with reference to the accompanying drawings.

If the printing medium, picked up by the pickup device 115, is jammed in the conveyance path 118 between the feeding roller 116 and the guide member 131, as illustrated in FIG. 9A, the user first opens the opening/closing cover 112 and then pulls the handle 134 to rotate the guide member 131 outward. In this case, the guide member 131 is rotated about the hinge shaft 133 as the hinge shaft 133, located in the first hinge hole 136, is rotated. After the guide member 131 is rotated by a predetermined angle, a further rotation of the guide member 131 is restricted by the stopper 139.

As illustrated in FIG. 9B, in a state wherein the stopper 139 restricts the rotation of the guide member 131, the planes 133a of the hinge shaft 133 are in parallel with the connecting portion 137. Then, if the user further pulls the handle 134, the hinge shaft 133 is moved substantially horizontally by a predetermined distance along the connecting portion 137 and is located in the second hinge hole 138. Accordingly, the guide member 133 is moved substantially horizontally toward a right upper position of the drawing by a predetermined distance along the connecting portion 137.

As illustrated in FIG. 9C, if a user releases the handle 134 after the hinge shaft 133 is moved into the second hinge hole 138, the guide member 131 is rotated about the hinge shaft 133 by a weight thereof, thereby being completely separated from the feeding roller 116. Accordingly, the user can easily remove the jammed printing medium from the feeding roller 116 through the aperture 113 opened by the opening/closing cover 112.

As described above, in the image forming apparatus according to the present embodiment, even if the printing medium conveyed by the feeding roller 116 is jammed, the jammed printing medium can be easily removed as the guide member 131 is rotated and simultaneously, moved substantially horizontally and upward to be moved away and spaced apart from the feeding roller 116.

Meanwhile, although a laser printer is exemplified as the image forming apparatus of the present invention in the above description, the present invention may alternatively employ other types of image forming apparatuses, such as a copying machine, a multi-function machine, etc. in place of the laser printer.

As apparent from the above description, in the image forming apparatuses according to various embodiments of the present general inventive concept, a jam-removal device is installed to a body of the image forming apparatus in an upwardly movable manner, to open or close an aperture formed in the body for the removal of a printing medium jammed in the body. With this configuration, as compared to the previously described conventional image forming apparatus in which a jam removal cover for the removal of a jammed printing medium is rotated in a horizontal direction of the ground surface about a hinge shaft, the present general inventive concept can achieve a reduced installation space of the image forming apparatus. That is, the image forming apparatuses of the present general inventive concept have no need for a wide space required for the rotation of the jam removal cover, and can be installed in a small space while guaranteeing easy removal of the jammed printing medium even when it is installed in a small space.

Although embodiments of the present general inventive concept have been shown and described, it would be appreciated by those skilled in the art that changes may be made in this embodiment without departing from the principles and spirit of the invention, the scope of which is defined in the claims and their equivalents.

What is claimed is:

1. An image forming apparatus comprising:
an image forming apparatus body having an aperture to provide removal of a jammed printing medium;
a printing engine installed at the image forming apparatus body to print an image on a printing medium supplied thereto; and
a jam-removal device installed at the image forming apparatus body in an upwardly movable manner to remove a jammed printing medium from the image forming apparatus body.

2. The image forming apparatus according to claim 1, wherein the jam-removal device comprises:
a frame coupled to the image forming apparatus body in a sliding movable manner; and
a discharge roller installed in the frame to convey the printing medium, which was printed with the image, to the outside of the image forming apparatus body.

3. The image forming apparatus according to claim 2, further comprising:
a position-fixing device to fix the frame to the image forming apparatus body.

4. The image forming apparatus according to claim 2, wherein any one of the frame and the image forming apparatus body comprises a sliding groove, and the other one of the frame and the image forming apparatus body comprises a guide protrusion to be inserted into the sliding groove in a sliding movable manner to guide the frame.

5. The image forming apparatus according to claim 4, wherein the sliding groove comprises an upper position-fixing member to fix the guide protrusion at an upwardly moved position.

6. The image forming apparatus according to claim 5, wherein the upper position-fixing member is an elastic member to be elastically deformed by a pressure force applied by the guide protrusion.

7. The image forming apparatus according to claim 4, wherein the sliding groove comprises a lower position-fixing member to fix the guide protrusion at a downwardly moved position.

8. The image forming apparatus according to claim 7, wherein the lower position-fixing member is an elastic member to be elastically deformed by a pressure force applied by the guide protrusion.

9. The image forming apparatus according to claim 2, wherein the discharge roller is coupled with a roller drive gear, and the image forming apparatus body comprises a drive gear to be engaged with the roller drive gear.

10. The image forming apparatus according to claim 2, further comprising:
a frame lifting device to vertically move the frame.

11. An image forming apparatus comprising:
a printing medium supply device to store and supply a printing medium;
a printing engine to form an image on the printing medium conveyed from the printing medium supply device;
a discharge structure from which the printing medium, having the image formed by the printing engine, is discharged; and
a jam-removal device installed on a conveyance path of the printing medium in an upwardly movable manner.

12. The image forming apparatus according to claim 11, further comprising:
an image forming apparatus body having an aperture,
wherein the jam-removal device is installed to the image forming apparatus body, to guide the printing medium, having passed through the printing engine, to the outside of the image forming apparatus body, and to open the aperture.

13. The image forming apparatus according to claim 11,
wherein a feeding roller is provided between the printing medium supply device and the printing engine, to convey the printing medium, supplied from the printing medium supply device, to the printing engine, and the jam-removal device comprises a guide member to guide the printing medium being conveyed by the feeding roller, and
wherein the guide member is rotated and moved substantially horizontally and upward, to remove the printing medium jammed in the conveyance path between the feeding roller and the guide member.

14. The image forming apparatus according to claim 13, wherein the jam-removal device further comprises:
a hinge shaft provided at the guide member and a hinge into which the hinge shaft is fitted.

15. The image forming apparatus according to claim 14, wherein the hinge shaft has a double D-cut shape having two opposite planes.

16. The image forming apparatus according to claim 15, wherein the hinge comprises:
a first hinge hole to receive the hinge shaft while the conveyance path is defined between the feeding roller and the guide member;
a connecting portion connected with the first hinge hole to allow a horizontal movement of the hinge shaft located in the first hinge hole; and
a second hinge hole connected with the connecting portion to allow the hinge shaft horizontally moved through the connecting portion to be rotated therein.

17. The image forming apparatus according to claim 16, wherein a stopper is provided below the feeding roller to restrict a rotation of the guide member such that the planes are oriented to be parallel to the connecting portion when the hinge shaft is located in the first hinge hole.

18. A jam-removal method of an image forming apparatus, the method comprising:
sensing a jam error of a printing medium being conveyed to a discharge structure of an image forming apparatus body;
stopping an operation of a printing medium discharge roller when the printing medium being conveyed to the discharge structure is jammed;
opening an aperture formed in the discharge structure by upwardly moving a jam-removal device covering the aperture, to remove the jammed printing medium; and
forcibly discharging the printing medium through the aperture.

19. The method according to claim 18, wherein, during the opening of the aperture, the jam-removal device is sliding moved by a predetermined distance so as not to be separated from the image forming apparatus body.

20. An image forming apparatus, comprising:
an image forming apparatus body having an aperture in which recording media having images printed thereon are ejected therefrom;
a printing engine within the image forming apparatus body to print an image on the recording media; and
a jam-removal device including a frame slidingly installed at the aperture to be slidable in a direction perpendicular to the direction in which the recording media are ejected therefrom and along an outer surface of the image forming apparatus body such that a jammed recording medium within the image forming apparatus body can be accessed by sliding the jam-removal device.

21. The image forming apparatus according to claim 20, wherein the jam-removal device comprises:
elongated sliding grooves along opposing inner surfaces of the aperture; and
guide protrusions extending outwardly from opposing outer surfaces of the frame to slide along inner surfaces of corresponding ones of the elongated sliding grooves.

22. The image forming apparatus according to claim 21, wherein the elongated sliding grooves comprise:
first position fixing members at first ends thereof to limit the sliding movement of the guide protrusions in a first direction; and
second position fixing members at second ends thereof to limit the sliding movement of the guide protrusions in a second direction.

23. The image forming apparatus according to claim 22, wherein the first and second position fixing members are formed of an elastic material to be elastically deformed when a predetermined amount of pressure is applied thereto by the respective guide protrusions due to sliding movement of the frame.
